(19) United States
(12) Patent Application Publication
(10) Pub. No.: US 2009/0025864 A1
(43) Pub. Date: Jan. 29, 2009

(54) Engine bay mask

(76) Inventor: Randy N. Fox, Bristow, VA (US)

Correspondence Address: WENDEROTH, LIND & PONACK, L.L.P., 2033 K STREET N. W., SUITE 800, WASHINGTON, DC, 20006-1021, US

(21) Appl. No.: 12/219,674

(22) Filed: Jul. 25, 2008

Related U.S. Application Data
(60) Provisional application No. 60/935,143, filed on Jul. 27, 2007.

(51) Int. Cl. B05C 11/00; B29C 65/00

(52) U.S. Cl. 156/196; 118/504

(57) ABSTRACT

A masking composite including an aluminum foil layer, a paper fiber layer, and an adhesive layer disposed between the aluminum foil layer and the paper fiber layer. The masking composite is sufficiently pliable to wrap around a component having an irregular contour without the need for taping the masking composite to the component.

This application claims the benefit of U.S. Provisional Application No. 60/935,143 filed Jul. 27, 2007.

### BACKGROUND OF THE INVENTION

1. Field of the Invention

This invention relates to an engine bay mask material used for masking parts of an article or a substrate to be coated.

2. Description of the Related Art

Paper mask currently available in the autobody repair industry does not perform well, and requires an inordinate amount of time to apply. Further, conventional paper masks are not able to conform to the shape of the item to be masked without the support of adhesive tape, thereby necessitating significant additional labor and cost. In addition to not being able to conform to a shape without using an adhesive tape, the known paper masks are not durable. For example, paper masks can be easily torn, ripped, and cut when masking objects with irregular contours. Also, since the known masks are applied with tape, the surface being protected must be reasonably clean so that the tape will hold the mask in place. Accordingly, significant amounts of time are required to clean the surface being protected. Also, when applying mask to, e.g., hydraulic or electrical lines, not only is the work tedious, the task of removing the tape is difficult and usually requires cutting the tape away from the lines. This operation can often result in the line being cut.

### SUMMARY OF THE INVENTION

An object of this invention is to provide an engine bay mask which does not require the support of adhesive tape to conform to objects with irregular contours. In particular, the mask of the present invention comprises an aluminum foil layer and a paper fiber layer, and is sufficiently pliable to wrap around components of all shapes and sizes. Another object of this invention is to provide an engine bay mask which improves quality in the autobody repair industry, increases production, reduces labor, and is inexpensive and easy to manufacture.

In the autobody repair industry, a pliable aluminum foil mask is important when handling and applying the mask to engine bay components surrounding the engine bay compartment of an automobile. Since aluminum foil in not sufficiently pliable, the mask of the present invention includes a paper fiber layer to provide the necessary pliability.

A mask with an aluminum layer and a paper fiber layer also allows coatings, paints, stains, waterborne paint, or varnishes to adhere to the mask after a curing process or an air drying process is complete. Without the paper fiber layer, the coating, paint, stain, waterborne paint or varnish buildup will delaminate, scatter, or flake from the aluminum foil, which in turn could contaminate and adhere to the refinished item, resulting in a defective and poor quality item.

The present invention is applicable in masking items of any substrate for the purpose of applying coatings, such as paint, epoxy, stains, waterborne paint, varnish, etc. The mask can be used in the autobody collision repair industry and other industries that apply coatings. The mask wraps around components of all types to ensure complete coverage so that paint or other coatings can be applied to inner fender wells, core supports, frame rails, shock towers, fire walls, and other autobody parts.

The mask can be used in any industry in which coatings, paints, stains, varnishes, waterborne and epoxy are typically applied. For example, the mask may be used to mask air conditioner lines, wiring, batteries, fuse boxes, radiators, hoses, engines, and headlight housings. The mask may also be used to mask chains, hydraulic lines, belts, pulleys, and other items encountered when refinishing industrial equipment, such as farming vehicles and industrial vehicles, e.g., dump trucks, cement trucks, cranes, etc. The mask is easily applied, and thus decreases the amount of labor associated with the application of a coating. Thus, the mask effectively increases production and improves quality, which equates to cost savings.

Additional advantages, objects, and features of the invention will become apparent to those of ordinary skill in the art from the following description.

### BRIEF DESCRIPTION OF THE DRAWINGS

The present invention will be described in detail with reference to the following drawings in which like reference numerals refer to like elements, wherein:

FIG. 1 is a cross-sectional view of a mask constructed in accordance with the present invention;

FIG. 2 is a view of the mask during a manufacturing process; and

FIG. 3 is a schematic view of the mask of FIG. 1 covering an engine bay component.

### DETAILED DESCRIPTION OF THE INVENTION

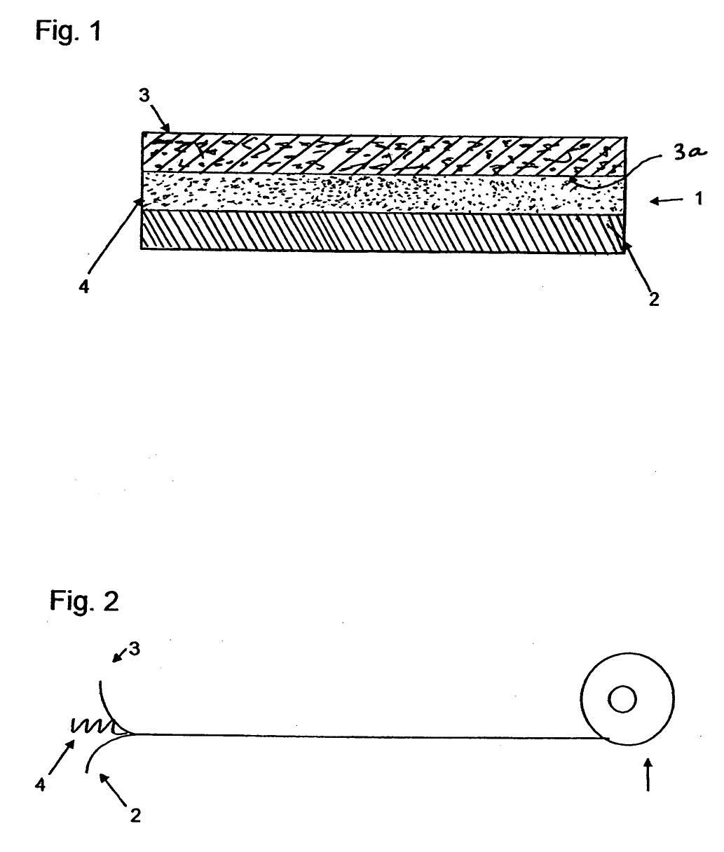

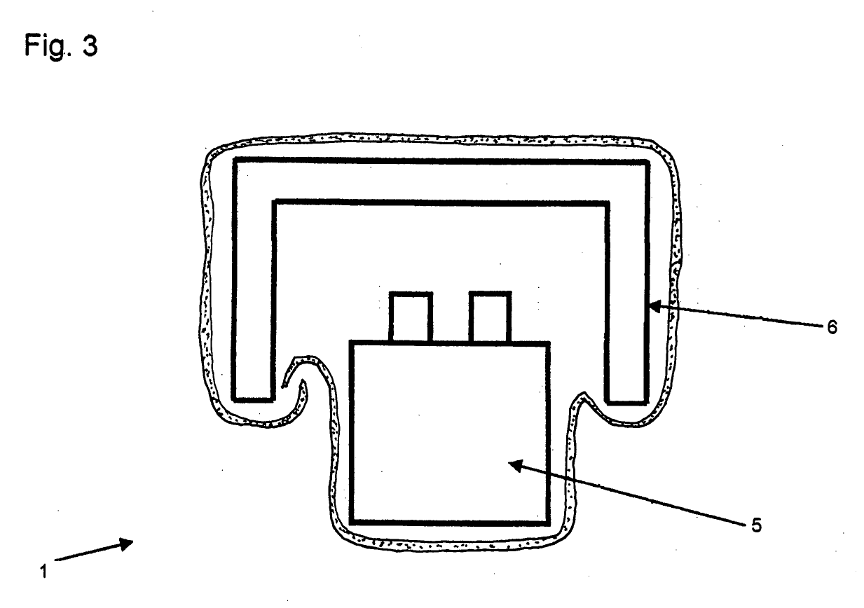

As illustrated in FIG. 1, the mask (1) includes an aluminum foil layer (2) and a paper fiber layer (3), which is disposed on one side of the aluminum foil layer (2). The aluminum foil layer (2) and paper fiber layer (3) are combined with an adhesive (4). As shown in FIG. 3, the mask is pliable and does not require an adhesive tape to conform to components having an irregular contour, such as a battery (5) and battery box (6). The mask can be baked in an oven or an autobody spray booth, but the temperature of the mask should not exceed 200 degrees Fahrenheit. In addition, the mask is chemical resistant, resistant to humidity, and resistant to extreme cold. Also, as illustrated in FIG. 2, the mask is adapted to be dispensed from a roll. The width of the mask may vary depending on the desired application. For example, the mask may be 6, 8, or 36 inches wide.

The paper fiber layer 3 should be provided with a coating 3a such as a polycoat, e.g., a low density polyethylene coating. The polycoat side of the paper fiber layer opposes the aluminum foil layer and is fixed thereto by a water-based adhesive. This arrangement prevents the adhesive from being exposed to the applied paint or other coatings. The coating on the paper fiber layer functions to prevent the paint or other applied coatings from degrading the adhesive due to contact with the paint or other coatings, which would otherwise bleed through an uncoated paper layer. If the applied coatings were allowed to come into contact with the adhesive, the foil layer and the paper fiber layer could delaminate. The paper fiber layer is essential in providing the mask with the necessary durability and it allows the paint or other applied coatings to cling to the mask even upon removal of the mask from the article being protected. The paper fiber layer also provides the mask with the necessary pliability. An aluminum foil layer alone could conform to an irregular surface of an article, such as a battery, but it would not be sufficiently durable. Also, a mask formed of an aluminum foil layer and a resin layer would lack the necessary pliability and would not allow the applied coating to sufficiently cling to the mask. The overspray would easily run off or flake off the exposed foil or resin surface.

The gage of the aluminum foil layer should be selected so that the composite mask will hold its shape when applied to a surface of an article to be protected. Note, if the foil is too thin, it will not have sufficient strength to hold the shape of the article being protected. However, if the aluminum foil layer is too thick, the resulting product will be too expensive.

A preferred embodiment of the mask includes a paper fiber layer formed of 25 lb bleached kraft paper coated with 7 lb extruded “500 LDPE” (low density polyethelene). The total basis weight of the paper fiber layer is 32 lb (total caliper weight of 2-2.5 pt). The aluminum foil layer is a 0.0008 standard converter aluminum foil. The paper fiber layer and the aluminum foil layer are adhered to each other with a water based acrylic adhesive. The mask is produced by laminating the aluminum foil to the LDPE coated side of the paper fiber layer with the water based acrylic adhesive. The total thickness of the finished mask is approximately 2.8-3.3 pt; and the weight of the finished mask is approximately 33 lbs per ream (500 sheets, 23×36″).

The above-described embodiment is exemplary, and is not intended to be limiting. Moreover, it should be understood that other modifications and variations will be apparent to those skilled in the art, without departing from the spirit or scope of the present invention. Furthermore, alternative uses will also be apparent to those skilled in the art.

What is claimed is:

1. A pliable masking composite for masking a component having a contoured surface, said masking composite comprising: an aluminum layer; a paper fiber layer; and an adhesive layer disposed between said aluminum layer and said paper fiber layer, said masking composite being adapted to conform to the contoured surface of the component.

2. The pliable masking composite as claimed in claim 1, wherein the paper fiber layer comprises a paper layer provided with an extruded low density polyethylene coating.

3. The pliable masking composite as claimed in claim 1, wherein the paper fiber layer is provided with a protective coating facing the aluminum layer.

4. A method of protecting an article during a coating process, the method comprising:
providing a pliable mask formed of an aluminum foil layer and a paper fiber layer adhered with an adhesive to the aluminum foil layer; masking the article with a contoured surface utilizing the pliable mask by wrapping the pliable mask around the contoured surface of the component so that the pliable mask conforms to the contoured surface of the article.
